(19) United States
(12) Patent Application Publication
(10) Pub. No.: US 2009/0150979 A1
(43) Pub. Date: Jun. 11, 2009

(54) NETWORK SYSTEM, NETWORK METHOD, AND TERMINAL AND PROGRAM THEREFOR

(75) Inventor: Shozo FUJINO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/332,098

(22) Filed: Dec. 10, 2008

(30) Foreign Application Priority Data
Dec. 11, 2007 (JP) 2007-319084

(51) Int. Cl. H04L 9/32

(52) U.S. Cl. 726/4

(57) ABSTRACT

A network system includes a first terminal having authority to access content, and a second terminal, wherein the first terminal comprises a first limited communication unit which performs limited communication with the second terminal, wherein the second terminal comprises a second limited communication unit which performs limited communication with the first terminal; and wherein the second terminal acquires certification information for authenticating access to the content from the first terminal, using the limited communication performed by the first and second limited communication units, if a predetermined relationship is confirmed between the first terminal and the second terminal.

This application is based upon and claims the benefit of priority from Japanese patent application No. 2007-319084, filed on Dec. 11, 2007, the disclosure of which is incorporated herein its entirely by reference.

### BACKGROUND

1. Technical Field

The present invention relates to a network system, a terminal, a network method, and a program for acquiring and accessing content between a plurality of terminals.

2. Description of the Related Art

Conventionally, in a case where a user who owns a terminal which manages a plurality of kinds of various content makes another user acquire the content, there is a method in which the content is stored in a storage medium or the like and it is handed over, and a method in which terminals of users are connected through a network such as a LAN or WAN and the content is transmitted therethrough.

Further, as a method for accessing content to a limited number of concerned parties and the like, there is a method by a file sharing mode in which the content is uploaded to a server installed on a network and each of the concerned parties is notified of a password for downloading the content, a method in which the content is stored in a storage medium or the like and it is handed over as described above, a method in which the content is sent as an attachment to a mail, a method using Peer-to-Peer (P2P) mode communication, and the like.

On the other hand, as mobile terminals which are usually carried around by users, there are a mobile telephone, a PHS, a PDA, a notebook computer, and the like. Among them, mobile telephones have been reduced in size and weight so that the users always carry the mobile telephone with them. Then, between these mobile telephones, communication is allowed including infrared, contact/contactless, wired LAN, wireless LAN, Bluetooth, and ZigBee communications, and the like, and content can also be accessed using such mobile terminals.

An authentication method of a wireless communication device described in Japanese Patent Laid-Open No. 2007-74393 (hereinafter “Patent Document 1”), when a client device within a certain distance from a host device is discovered, an authentication code is generated and an access right is set such that it is stored in the client device. Without difficult operation, pairing between the host device and client device is allowed, and a wireless communication system and service thereof having enhanced security are provided.

A system described in Japanese Patent Laid-Open No. 2005-217646 (hereinafter “Patent Document 2”) includes one or more devices which form a network, a certification authority which certifies a device, and a mobile terminal which communicates with the certification authority and performs setting and control with respect to each device. Each time any device participates in the network, a device certificate which certificates the device is generated by the certification authority, and the device certificate is signed by a network certificate. The mobile terminal receives the signed device certificate and sets it to each device, so that the secure network is easily built.

An identification system described in Japanese Patent Laid-Open No. 2003-337905 (hereinafter “Patent Document 3”) includes a mobile communication device which outputs information as a certificate that each user has a predetermined identity, a certificate information management server which stores certificate information, a validity period, and invalidation information associated with each user, and a server which enables certificate application to be downloaded. If the validity period has not been completed and the invalidation information does not exist after a user operates the mobile communication terminal and downloads and starts the application, an image of a certificate indicating that the user has a predetermined identity is allowed to be displayed.

However, in the method by the file sharing mode, the technique described in Patent Document 1, and the techniques described in Patent Documents 2, 3, among conventional methods, a password or an authentication code for downloading content is sent through a network or with a mail. At this time, there is a risk of leaking the password to a terminal owned by a user other than concerned parties. In addition, in a case where this password or content itself is encrypted to be acquired, it is necessary to distribute a tool or program for encryption and decryption to all of users such as concerned parties and make them install the tool or program, and difficulties may be caused when there are many concerned parties and the like.

In a case where content is sent as an attachment to a mail, the load on a server is increased when the data volume of the content is large, and there is a possibility that the content cannot be sent due to the capacity limits on the server side if the data volume increases. The method using the Peer-to-Peer (P2P) mode has a similar problem.

On the other hand, when the method in which content is stored in a storage medium or the like and the storage medium is handed over, there is a problem that, if an actual location where the server is installed is remote from an address at which a user exists, the method cannot handle this case and therefore handing it over is difficult.

### SUMMARY OF THE INVENTION

An aspect of the present invention is to provide a technology which prevents the risk of leaking content to others and provides enhanced security.

Embodiments of the present invention also overcome disadvantages not described above. Indeed, embodiments of the present invention may not overcome any of the problems described above.

An aspect of the invention concerning a network system including a first terminal having authority to access content, and a second terminal, wherein the first terminal comprises a first limited communication unit which performs limited communication with the second terminal, wherein the second terminal comprises a second limited communication unit which performs limited communication with the first terminal, and wherein the second terminal acquires certification information for authenticating access to the content from the first terminal, using the limited communication performed by the first and second limited communication units, if a predetermined relationship is confirmed between the first terminal and the second terminal.

Also, an aspect of the present invention concerning a second terminal for communicating with a first terminal having authority to access content stored in a sever, including, a second limited communication unit which performs limited communication with the first terminal, wherein the second terminal acquires certification information, which is sent to the first terminal from the server, from the first terminal, using the limited communication performed by the second limited communication unit.

Also, an aspect of present invention concerning a third terminal for communicating with a first terminal having authority to access content stored in a server and a second terminal capable of performing limited communication with the first terminal, including, a content acquiring unit which acquires the content from the server, a authentication information requesting unit which makes a request to the second terminal for authentication information created by using certification information for authenticating access to the content acquired by the second terminal, using the limited communication, an authentication information acquiring unit which acquires the authentication information sent from the second terminal in response to the request for the authentication information made by the authentication information requesting unit, and a first content authentication unit which authenticates the content acquired by the content acquiring unit, using the authentication information acquired by the authentication information acquiring unit.

Also, an aspect of present invention concerning a third terminal for communicating with a first terminal having authority to access content stored in a server and a second terminal capable of performing limited communication with the first terminal, including, a content acquiring unit which acquires the content from the server, a certification information acquiring unit which acquires certification information acquired by the second terminal, using the limited communication, and a second content authentication unit which authenticates the content acquired by the content acquiring unit, using the certification information acquired by the certification information acquiring unit.

Also an aspect of the present invention concerning a network method including a limited communication operation comprising performing limited communication between a first terminal, having authority to access content, and a second terminal, and a certification information sending operation comprising sending certification information for authenticating access to the content from the first terminal to the second terminal, using the limited communication performed by the limited communication operation, if a predetermined relationship is confirmed between the first terminal and the second terminal.

Also, an aspect of the present invention concerning a method with which a second terminal communicates with a first terminal having authority to access content stored in a server, including, a limited communication operation comprising performing limited communication with the first terminal, and a certification information acquiring operation comprising acquiring certification information, which is sent to the first terminal from the server, from the first terminal, using the limited communication performed by the limited communication operation.

Also, an aspect of the present invention concerning a method with which a third terminal communicates with a first terminal having authority to access content stored in a server and a second terminal capable of performing limited communication with the first terminal, including, a content acquiring operation comprising acquiring the content from the server, a authentication information requesting operation comprising making a request to the second terminal for authentication information created by using certification information for authenticating access to the content acquired by the second terminal, using the limited communication; an authentication information acquiring operation comprising acquiring the authentication information sent from the second terminal in response to the request for the authentication information made by the authentication information requesting operation, and a first content authentication operation comprising authenticating the content acquired by the content acquiring operation, using the authentication information acquired by the authentication information acquiring operation.

Also, an aspect of the present invention concerning a method with which a third terminal communicates with a first terminal having authority to access content stored in a server and a second terminal capable of performing limited communication with the first terminal, comprising, a content acquiring operation comprising acquiring the content from the server, a certification information acquiring operation comprising acquiring certification information acquired by the second terminal, using the limited communication, and a second content authentication operation comprising authenticating the content acquired by the content acquiring operation, using the certification information acquired by the certification information acquiring operation.

Also, an aspect of the present invention concerning a computer readable tangible memory containing a program of instructions for enabling a computer for networking, to execute processes, comprising, limited communication process comprising performing limited communication between a first terminal, having authority to access content, and a second terminal, and certification information sending process comprising sending certification information for authenticating access to the content from the first terminal to the second terminal, using the limited communication performed by the limited communication process, if a predetermined relationship is confirmed between the first terminal and the second terminal.

Also, an aspect of the present invention concerning a computer readable tangible memory containing a program of instructions for enabling a computer, serving as a second terminal that communicates with a first terminal having authority to access content stored in a server, to execute processes, including, limited communication process comprising performing limited communication with the first terminal, and certification information acquiring process comprising acquiring certification information, which is sent to the first terminal from the server, from the first terminal, using the limited communication performed by the limited communication process.

Also, an aspect of the present invention concerning a computer readable tangible memory containing a program of instructions for enabling a computer, serving as a third terminal that communicates with a first terminal having authority to access content stored in a server and a second terminal capable of performing limited communication with the first terminal, to execute processes, including, content acquiring process comprising acquiring the content from the server, authentication information requesting process comprising making a request to the second terminal for authentication information created by using certification information for authenticating access to the content acquired by the second terminal, using the limited communication, authentication information acquiring process comprising acquiring the authentication information sent from the second terminal in response to the request for the authentication information made by the authentication information requesting process, and first content authentication process comprising authenticating the content acquired by the content acquiring process, using the authentication information acquired by the authentication information acquiring process.

Also, an aspect of the present invention concerning a tangible computer readable memory containing a program of instructions for enabling a computer, serving as a third terminal that communicates with a first terminal having authority to access content stored in a server and a second terminal capable of performing limited communication with the first terminal, to execute processes, including, content acquiring process comprising acquiring the content from the server, certification information acquiring process comprising acquiring certification information acquired by the second terminal, using the limited communication, and second content authentication process comprising authenticating the content acquired by the content acquiring process, using the certification information acquired by the certification information acquiring process.

### BRIEF DESCRIPTION OF THE DRAWINGS

FIG. 1 is an explanatory diagram which shows a configuration of a network system according to the first embodiment.

FIG. 2 is a sequence diagram which shows operation of the network system according to the first embodiment.

FIG. 3 is an explanatory diagram which shows a configuration of a network system according to the second embodiment.

FIG. 4 is a sequence diagram which shows operation of the network system according the second embodiment.

FIG. 5 is a configuration diagram which shows a configuration of the first example corresponding to the network system according to the first embodiment.

FIG. 6 is a configuration diagram which shows a configuration of the second example corresponding to the network system according to the first embodiment.

FIG. 7 is a configuration diagram which shows a configuration of the third example corresponding to the network system according to the second embodiment.

### DESCRIPTION OF EMBODIMENTS

### First Embodiment

Hereinafter, a first embodiment of the present invention is described, using drawings.

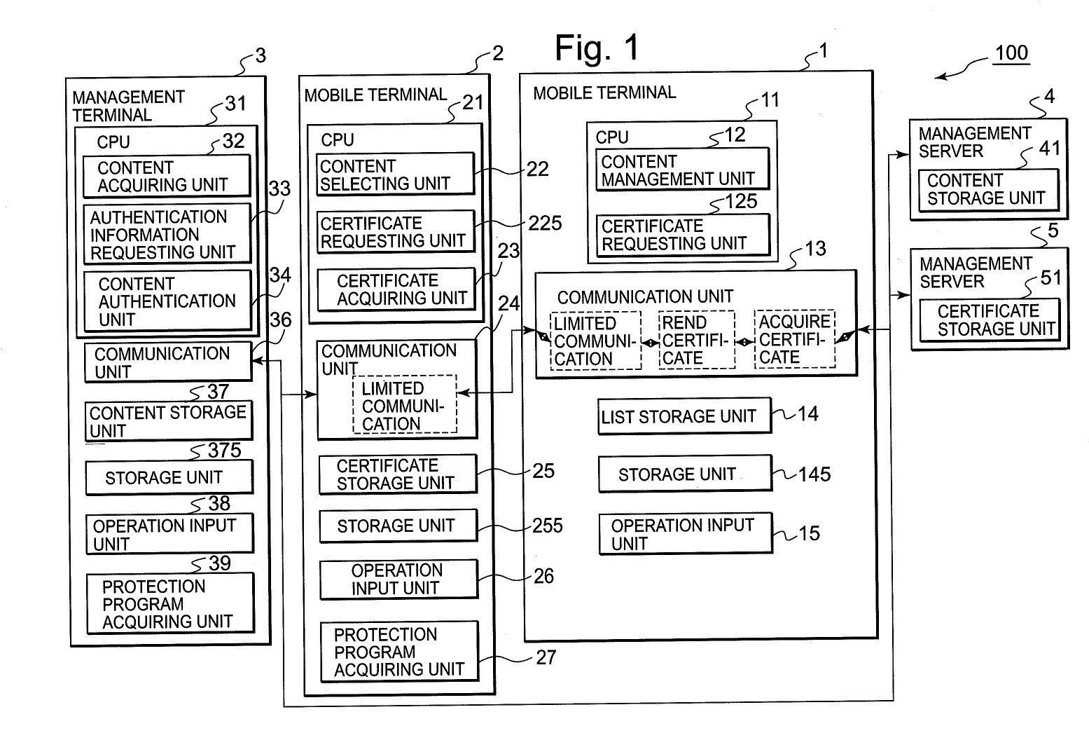

FIG. 1 is an explanatory diagram which shows a configuration of a network system 100 according to the first embodiment. The network system 100 includes mobile terminals 1, 2, a management terminal 3, a management server 4, and a management server 5. The mobile terminal 1, which is carried by a user A, is a terminal for generating and managing a plurality of kinds of content. The mobile terminal 2 is a terminal which is carried by a user B who may be different from the user A or may be the same as the user A. The management terminal 3, which is also owned by the user B, may have a larger equipment size than the mobile terminal 2, performs information management and the like. The management server 4 stores content generated by the user A in a content storage unit 41. The management server 5 stores a certificate corresponding to the content stored by the management server 4, in a certificate storage unit 51.

As used herein, a certificate is data for creating authentication information which is used for authentication for accessing content corresponding to the respective certificate, and the content cannot be accessed unless authentication is performed using this certificate. With respect to content stored in the management server 4, only the mobile terminal 1 has authority to access it, as an example in this embodiment, and a certificate stored in the management server 5 is sent only to this mobile terminal 1 and acquired by the mobile terminal 1. This certificate corresponds to certification information.

The mobile terminal 1 includes a CPU 11, a communication unit 13, a list storage unit 14, a storage unit 145, and an operation input unit 15. The CPU 11 performs processing by executing various programs stored in the storage unit 145. The communication unit 13 communicates to the mobile terminal 2 and the management servers 4, 5 using a wireless or wired communication. In the list storage unit 14, a list of content stored in the management server 4 is stored. On the operation input unit 15, the user A performs information input or operation with respect to the mobile terminal 1.

The CPU 11 executes a program stored in the storage unit 145, thereby performing processing for causing the management servers 4, 5 to store and manage content or a certificate. This processing corresponds to processing in the content management unit 12. In addition, the CPU 11 performs processing to make a request to the management server 5 for a certificate based on authority to access content in response to a request from a certificate requesting unit 225 of the mobile terminal 2, as is described later. This processing corresponds to processing in the certificate requesting unit 125. After requesting the certificate, the CPU 11 receives the certificate which is sent from the management server 5 in response to this request, and performs processing for sending the certificate to the mobile terminal 2, using limited communication.

The communication unit 13 performs communication between the mobile terminal 1 and the management terminal 3, using wired communication by a wired LAN though a cable or wireless communication by a wireless LAN. Further, the communication unit 13 is capable of performing limited communication which is communication between only the mobile terminal 1 and the mobile terminal 2 but exclusive of any other terminals. The limited communication is used, for example, in a file sharing mode in which the mobile terminal 1 and the mobile terminal 2 are connected so that they can acquire information from one another.

The limited communication is implemented using, for example, contact or contactless communication, infrared communication, human body communication, or the like. The limited communication means communication in which terminals with which one terminal can communicate at the same time is limited to certain terminals, for example, a certain single terminal. The limited communication function may be performed in a situation where the distance between the mobile terminals 1 and 2 is close, for example, when the users A, B having the mobile terminals 1, 2 actually meet and confirm each other's existence in their sight. Also, the limited communication may be performed even where the distance between the mobile terminals 1 and 2 is far if the limited communication function can be performed with any kind of confirmation.

In the list storage unit 14, a list of content is stored which is created corresponding to content being stored in the management server 4. In the storage unit 145, various applications and programs to be executed by the CPU 11 are stored. The operation input unit 15 is composed of a plurality of kinds of buttons for the user A to operate the mobile terminal 1.

The mobile terminal 2 includes a CPU 21, a communication unit 24, a certificate storage unit 25, a storage unit 255, an operation input unit 26 and a protection program acquiring unit 27. The CPU 21 performs processing by executing various programs stored in the storage unit 255. The communication unit 24 communicates with the mobile terminal 1 and the management terminal 3, using a wireless or wired communication. The certificate storage unit 25 stores a certificate corresponding to content which the user B tries to acquire. On the operation input unit 26, the user B performs information input or operation with respect to the mobile terminal 2.

The CPU 21 executes a program stored in the storage unit 255 to perform processing for selecting content stored in the management server 4 according to operation of the user B using the operation input unit 26. This processing corresponds to processing in a content selecting unit 22. In addition, the CPU 21 performs processing for making a request to the mobile terminal 1 for a certificate corresponding to content selected by the content selecting unit 22. This processing corresponds to processing in a certificate requesting unit 225. Then, the CPU 21 performs processing for acquiring the certificate sent to the mobile terminal 1 from the management server 5 in response to the request made by the CPU 21, from the mobile terminal 1, using the limited communication. This processing corresponds to processing in a certificate acquiring unit 23.

The communication unit 24 communicates with the mobile terminal 1 and the management terminal 3, using wired communication by a wired LAN though a cable or wireless communication by a wireless LAN. Further, the communication unit 24 communicates with the mobile terminal 1 in the file sharing mode as in the case of the communication unit 13 of the mobile terminal 1, and is allowed at this time to enable the limited communication function.

In the certificate storage unit 25, a certificate acquired from the mobile terminal 1 by the certificate acquiring unit 23 is stored. In the storage unit 255, various applications and programs to be executed by the CPU 21 are stored. The operation input unit 26 is composed of a button for selecting content which the user B tries to acquire, and a plurality of kinds of buttons for operating the mobile terminal 2. The protection program acquiring unit 27 acquires a file protection program for performing authentication of access to content, from an external network.

The management terminal 3 includes a CPU 31, a communication unit 36, a content storage unit 37, a storage unit 375, an operation input unit 38, and a protection program acquiring unit 39. The CPU 31 performs processing by executing various programs stored in the storage unit 375. The communication unit 36 communicates to the mobile terminal 2 and the management servers 4, 5 using a wireless or wired communication. In the content storage unit 37, content selected by the content selecting unit 22 is stored. On the operation input unit 38, the user B performs information input or operation with respect to the management terminal 3.

The CPU 31 executes a program stored in the storage unit 375 to perform processing for acquiring the content selected by the content selecting unit 22 from the management server 4. This processing corresponds to processing in a content acquiring unit 32. In addition, the CPU 31 performs processing for making a request to the mobile terminal 2 for authentication information created using a certificate acquired by the certificate acquiring unit 23. This processing corresponds to processing in an authentication information requesting unit 33. Further, the CPU 31 performs processing for acquiring, by the communication unit 36, the authentication information sent from the mobile terminal 2 in response to the request for the authentication information made by the authentication information requesting unit 33.

Then, the CPU 31 performs processing for performing authentication of the content acquired by the content acquiring unit 32 and accessing the content, using the authentication information acquired by the communication unit 36. This processing corresponds to processing in a content authentication unit 34.

The communication unit 36 communicates with the mobile terminal 2 and the management servers 4, 5, using wired communication by a wired LAN though a cable or wireless communication by a wireless LAN.

In the content storage unit 37, the content, acquired by the content acquiring unit 32 from the management server 4, is stored. In the storage unit 375, various applications and programs to be executed by the CPU 31 are stored. The operation input unit 38 is composed of a plurality of kinds of buttons for the user B to operate the management terminal 3. The protection program acquiring unit 39 acquires a file protection program for performing authentication of access to content, from the mobile terminal 2 or an external network.

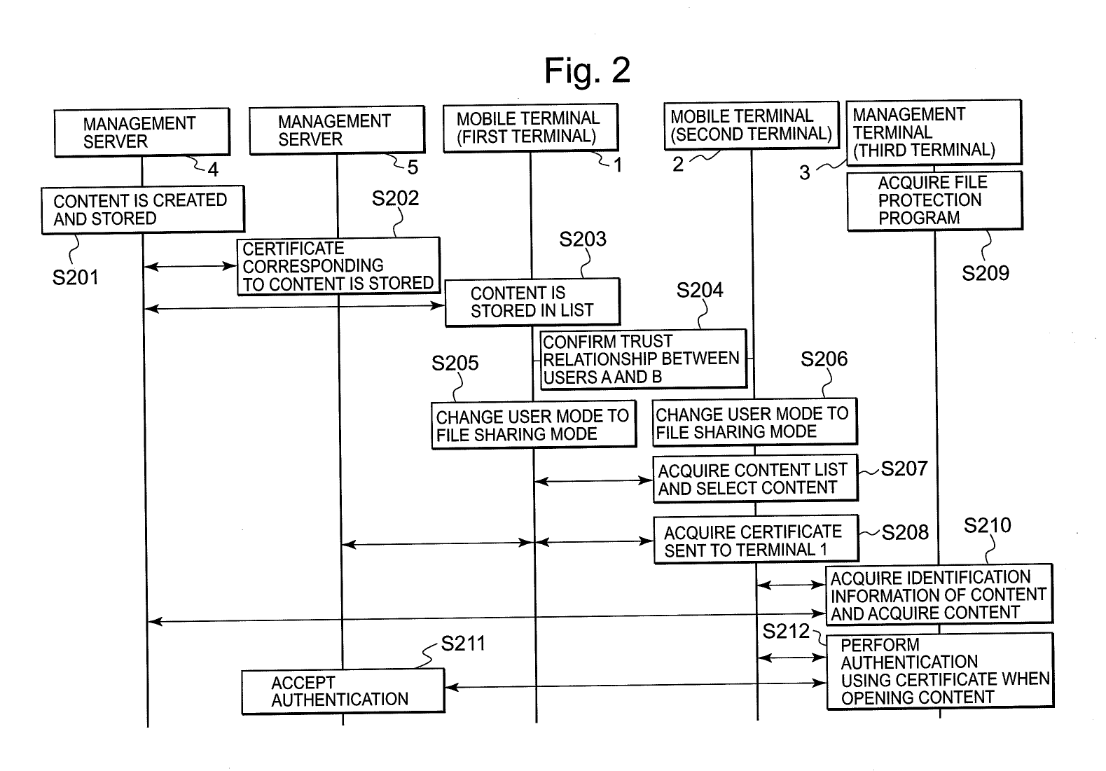

Aside from the above described component parts, the mobile terminals 1, 2, the management terminal 3, the management servers 4, 5 may be provided with component parts required to be used by the users A, B, such as a screen display unit using a display, a speaker or the like. As the management servers 4, 5, the mobile terminal 1, another terminal or device may be used if provided with a function of storing and distributing content and a certificate. Subsequently, operation of the network system 100 according to the first embodiment is described using a sequence diagram shown in FIG. 2. First, when the mobile terminal 1 is operated by the user A to generate or acquire content, the mobile terminal 1 communicates with the management servers 4, 5 using the communication unit 13.

Step S201: The mobile terminal 1 performs processing for sending the content to the management server 4 and storing the content therein. The mobile terminal 1 sends the content using the communication unit 13 and also sends information for requesting to store this content together. Upon receiving the content and the information for requesting, the management server 4 associates the content with identification information for identifying this content and stores the content associated with the identification information in the content storage unit 41.

Step S202: The management server 5 performs processing for creating and storing a certificate corresponding to the content stored in the management server 4. When the management server 4 stores the content in step S201 and sends information for requesting to create a certificate corresponding to the content, the management server 5 creates the certificate with reference to the content stored in the management server 4 in response to this request. Then, the management server 5 associates the created certificate with the identification information of the content and stores the certificate associated with the identification information in the certificate storage unit 51.

Step S203: The mobile terminal 1 performs processing for creating a list using the identification information of the content sent from the management server 5. When the management server 5 stores the certificate in step S202 and sends the identification information of the content corresponding to this certificate, the mobile terminal 1 receives this identification information. The mobile terminal 1 creates a list which displays, for example, a name, details and the like of the content, and associates the name of the content stored in the management server 4 in step S202 with the received identification information and stores the name of the content associated with the identification information in the list storage unit 14.

Step S204: In response to confirmation of a trust relationship between the users A and B, the mobile terminal 1 and the mobile terminal 2 connect to each other using the communication units 13 and 24, and perform communication processing. Specifically, when the users A, B meet or make contact with each other so as to confirm the trust relationship where there is no violation, false recognition, and the like about acquisition of the content, the mobile terminal 1 and the mobile terminal 2 send and receive a detection signal and a response signal between each other by the communication units 13, 24 so as to connect and communicate to each other.

Steps S205, S206: The mobile terminal 1 and the mobile terminal 2 switch each other's communication mode from a normal wired or wireless communication to the file sharing mode, and further perform processing for enabling the limited communication function using contact or contactless communication, infrared communication, or the like, by the communication units 13, 24.

Step S207: The mobile terminal 2 acquires a list of content from the mobile terminal 1 by the communication unit 24, and performs processing for selecting content according to operation by the user B using the content selecting unit 22. The mobile terminal 2 acquires the list of content stored in the list storage unit 14 in the step S203 from the mobile terminal 1 by the communication unit 24, and displays the list on a display or the like. Then, according to an operation by the user B with reference to the list of content using the operation input unit 26, the mobile terminal 2 selects any content in the list using the content selecting unit 22, and extracts identification information associated with the name of the selected content.

Step S208: The mobile terminal 2 performs processing for making a request to the mobile 1 for a certificate corresponding to the content selected by the content selecting unit 22 and acquiring the certificate from the mobile terminal 1 using the certificate requesting unit 225 and the certificate acquiring unit 23. The mobile terminal 2 sends the identification information extracted in the step S207 to the mobile terminal 1 and also sends information for requesting the certificate of the content corresponding to the identification information together using the certificate requesting unit 225. Upon receiving this request, the mobile terminal 1 makes a request to the management server 5 for the certificate associated with the identification information based on the authority to access the content that is owned by the mobile terminal 1, using the certificate requesting unit 125.

Upon receiving the request, the management server 5 sends the certificate to the mobile terminal 1, so that this certificate is acquired by the mobile terminal 1. The mobile terminal 1 sends the acquired certificate using limited communication to the mobile terminal 2 using the communication unit 13. The mobile terminal 2 acquires the sent certificate using the certificate acquiring unit 23 and stores the certificate in the certificate storage unit 25.

Step S209: The management terminal 3 performs processing for acquiring a file protection program for performing authentication for accessing content by the CPU 31, from the mobile terminal 2 or an external network.

Step S210: The management terminal 3 performs processing for acquiring the content selected by the content selecting unit 22 from the management server 4 using the content acquiring unit 32. The management terminal 3 acquires the identification information extracted in step S207 from the mobile terminal 2 and sends the identification to the management server 4 using the content acquiring unit 32, and also sends information for requesting the content corresponding to this identification information together. In response to this request, the management server 4 reads out the content associated with this identification information from the content storage unit 41 and sends the content to the management terminal 3. The management terminal 3 receives the sent content and stores the content in the content storage unit 37.

Steps S211, S212: The management terminal 3 performs processing for performing authentication using the certificate and accessing the content, using the authentication requesting unit 33 and the content authentication unit 34. Using the authentication requesting unit 33, the management terminal 3 sends information for requesting the authentication information created using the certificate acquired in step S207, to the mobile terminal 2. In response to this request, the mobile terminal 2 creates authentication information using the certificate stored in the certificate storage unit 25, and sends the authentication information to the management terminal 3.

Then, using the content authentication unit 34, the management terminal 3 acquires the authentication information sent from the mobile terminal 2 in response to this request, sends the acquired authentication information to the management server 5, and then performs authentication of the content stored in the content storage unit 37. The management server 5 receives the authentication information according to this authentication, updates information, for example, about “Lifetime” contained in the certificate, and then sends information for providing notification that the authentication is completed to the management terminal 3. Here, in the information about “Lifetime”, a period of validity period in which authentication with respect to content is enabled, a count of validity to use a certificate, and the like are contained. The management server 5 updates these information by reducing a value of such information according to the authentication.

In response to this notification, the management terminal 3 performs processing for accessing the content and displaying details of the content on the display or the like.

In the above described operation, the authentication of the content and access to the content are performed at the management terminal 3 while the certificate corresponding to the content accessed by the management terminal 3 remains stored in the mobile terminal 2. However, if the certificate is sent from the mobile terminal 2 to the management terminal 3, the processing of the steps S211, S212 may be executed as follows.

First, the management terminal 3 sends information for requesting the certificate acquired in the above described step S207 by CPU 31, to the mobile terminal 2. In response to this request, the mobile terminal 2 reads out the certificate stored in the certificate storage unit 25 and sends it to the management terminal 3. The management terminal 3 acquires this certificate.

Then, the management terminal 3 creates authentication information using the acquired certificate, sends the created authentication information to the management server 5, and then performs authentication of the content stored in the content storage unit 37. At this time, the management terminal 3 performs the authentication by executing the file protection program acquired in the step S207. The management server 5 receives the authentication information according to this authentication, and sends information for providing notification that the authentication is completed to the management terminal 3. In response to this notification, the management terminal 3 performs processing for accessing the content and displaying details of the content on the display or the like.

As described above, in the network system 100 in the first embodiment, after a trust relationship is confirmed between the users A and B, the mobile terminals 1 and 2 perform communication in the file sharing mode in which the limited communication function is enabled. Then, the mobile terminal 2 acquires a certificate sent to the mobile terminal 1 having authority to access content, and the management terminal 3 performs authentication and accesses the content. Therefore, compared to the conventional art, the risk of leaking a certificate and content to others is prevented so that enhanced security can be provided. For promoting information or service of a shop or the like by content, the mobile terminal 1 as a specific example may be a terminal installed in the shop or the like. In this case, a customer who has come to the shop can see information about the shop by acquiring the content from this terminal and referring to it.

In addition, since the management terminal 3 accesses content while the certificate remains stored in the mobile terminal 2, even if the content is acquired by another terminal from the management terminal 3, there is no risk of leaking the content unless certification information is created by the mobile terminal 2. Further, even if the mobile terminal 2 sends the certificate to another terminal, it is not used without limitation because there is a “Lifetime” restriction, and therefore the risk of leaking can be minimized.

Since the management terminal 3 receives authentication information sent from the mobile terminal 2 and performs authentication, the content may be accessed by another terminal performing fraudulent authentication using this authentication information. However, in this case, each authentication information is made identifiable, for example, assignment of a specific number for each creation of authentication information, and information for which authentication was once performed is prohibited from being reused, so that the risk of leaking can be prevented.

Since a certificate corresponding to content is created by the management server 5 and stored therein, the user B can acquire it in advance from the management server 5 using the mobile terminal 2 whether or not the content has been accessed by the management server 4.

Although the management servers 4, 5 are different servers in which content and a certificate are stored separately, these servers may be the same server. In addition, content and a certificate may be stored in a server or a device on an external network that is different from a network connected with the management servers 4, 5 and the mobile terminals 1, 2. Further, content and a certificate may be stored in the mobile terminal 1 without using the management servers 4, 5.

As a specific method for confirming a trust relationship in step S204, a method in which the users A, B actually meet and confirm each other's existence in their sight, or a method in which they make contact by telephone and confirm each other's voice may be used. Or, it may be a human body communication where information is sent and received through a human body or other methods.

### Second Embodiment

Hereinafter, a second embodiment of the present invention is described, using drawings.

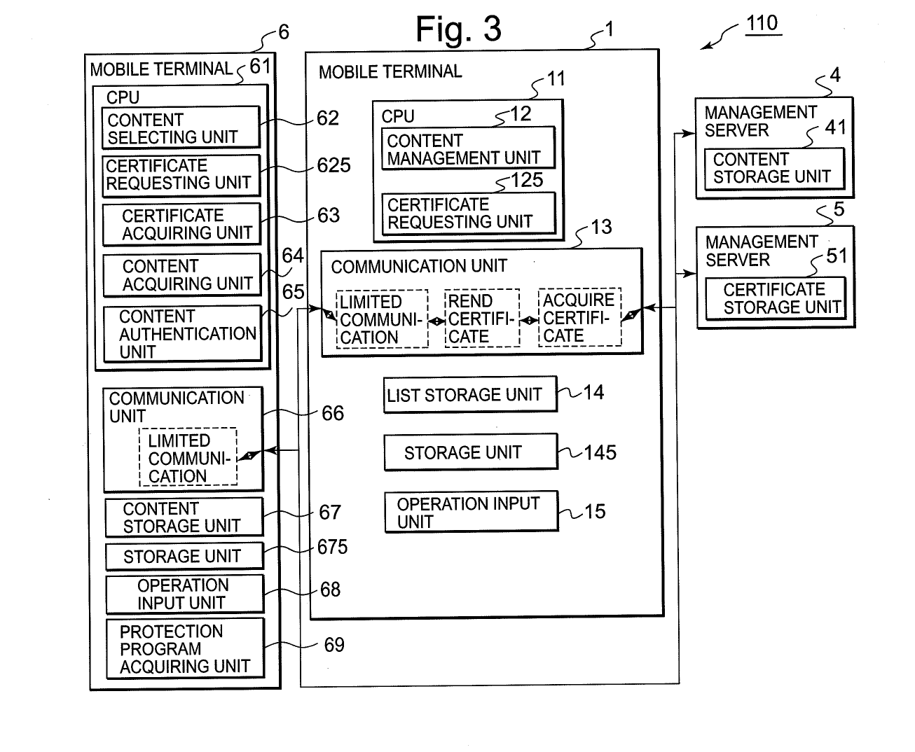

FIG. 3 is an explanatory diagram which shows a configuration of the network system 110 according to a second embodiment. The network system 110 includes a mobile terminal 6, a mobile terminal 1, a management server 4, and a management server 5. The mobile terminal 6 is a single terminal which is carried by the user B instead of the mobile terminal 2 and the management terminal 3 which are included in the network system 100 according to the first embodiment. The mobile terminal 1, the management server 4, and the management server 5 are respectively the same as the mobile terminal 1, the management server 4, and the management server 5 in the first embodiment, and description thereof will be omitted.

The mobile terminal 6 includes a CPU 61, a communication unit 66, a content storage unit 67, a storage unit 675, an operation input unit 68, and a protection program acquiring unit 69. The CPU 61 performs processing by executing various programs stored in the storage unit 675. The communication unit 66 communicates with the mobile terminal 1, the management server 4, and the management server 5 using a wireless or wired communication. In the content storage unit 67, content and a certificate acquired from the management server 4 and the management server 5 are stored. On the operation input unit 68, the user B performs information input or operation with respect to the mobile terminal 6.

The CPU 61 performs processing by executing programs stored in the storage unit 675. These processing correspond to the processing in a content selecting unit 62, a certificate requesting unit 625, a certificate acquiring unit 63, a content acquiring unit 64, and a content authentication unit 65. Functions of the content selecting unit 62, the certificate requesting unit 625, the certificate acquiring unit 63, the content acquiring unit 64, the content authentication unit 65, and the protection program acquiring unit 69 are respectively the same as the functions of the content selecting unit 22, the certificate requesting unit 225, the certificate acquiring unit 23, the content acquiring unit 32, the content authentication unit 34 and the protection program acquiring unit 27 which are included in the mobile terminal 2 and the management terminal 3 of the network 100 in the first embodiment, and description thereof will be omitted.

Also, configurations and functions of the others; the communication unit 66, the content storage unit 67, the storage unit 675, and the operation input unit 68 are respectively the same as those of the communication unit 24, the content storage unit 37, the storage unit 375, and the operation input unit 36 which are included in the mobile terminal 2 and the management terminal 3 of the network 100 in the first embodiment, and description thereof will be omitted.

The communication unit 66 is here allowed to communicate not only with the mobile terminal 1, but also with the management servers 4, 5 using a wireless or wired communication. In the content storage unit 67, there is stored not only content, but also a certificate acquired from the mobile terminal 1 by the certificate acquiring unit 63.

Aside from the above described component parts, the mobile terminal 6 is provided with component parts required to be used by the user B, such as a screen display unit using a display, a speaker or the like.

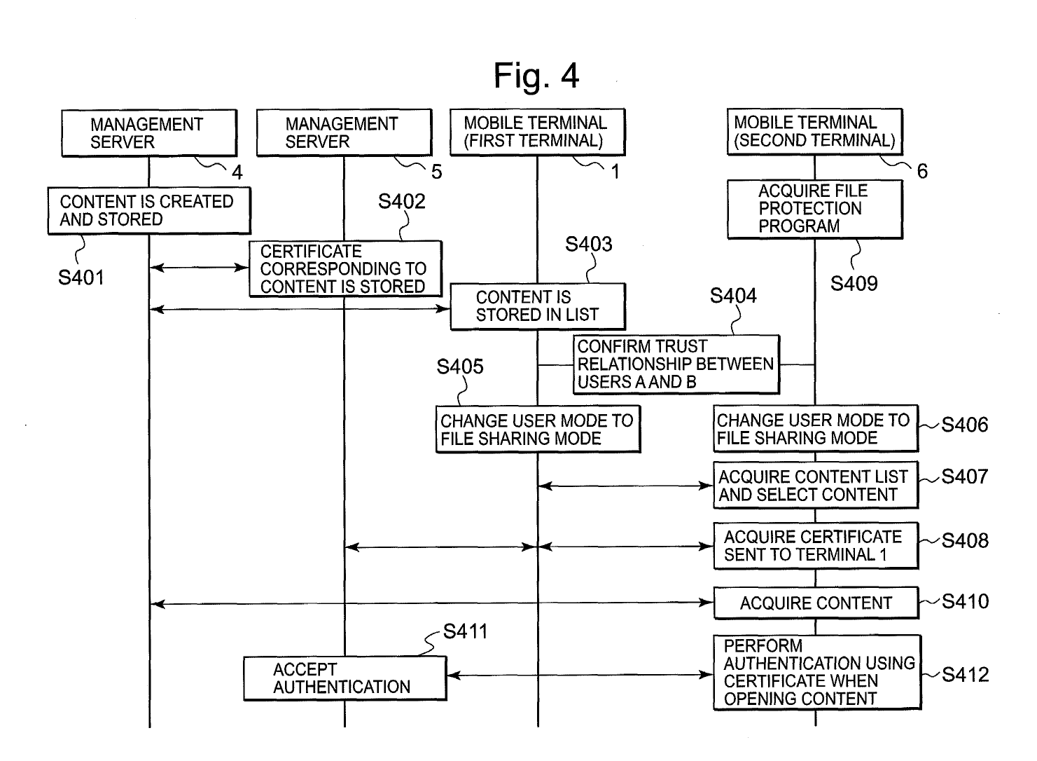

Subsequently, operation of the network system 110 according to the second embodiment will be described using a sequence diagram shown in FIG. 4. First, when the mobile terminal 1 is operated by the user A to generate or acquire content, the mobile terminal 1 communicates with the management servers 4, 5 using the communication unit 13.

Steps S401 to S408: Processing of steps S401 to S408 are the same, if the mobile terminal 6 is replaced with the mobile terminal 2, as the processing performed among the management servers 4, 5 and the mobile terminals 1, 2 in steps S201 to S208 in the above described first embodiment, and thus description thereof will be omitted. In the following description, it is assumed that each processing in steps S401 to S408 corresponding respectively to steps S201 to S208 has already been performed.

Step S409: The mobile terminal 6 performs processing for acquiring a file protection program for performing authentication for accessing content by the CPU 61, from the external network.

Step S410: The mobile terminal 6 performs processing for acquiring the content selected by the content selecting unit 62 from the management server 4 using the content acquiring unit 64. Using the content acquiring unit 64, the mobile terminal 6 sends identification information extracted in the above described step S407 to the management server 4, and also sends information for requesting the content corresponding to this identification information together. In response to this request, the management server 4 reads out the content associated with this identification information from the content storage unit 41 and sends the content to the mobile terminal 6. The management terminal 6 receives the sent content and stores the content in the content storage unit 67.

Steps S411, S412: Using the content authentication unit 65, the mobile terminal 6 performs processing for performing authentication using a certificate and accessing the content. The mobile terminal 6 creates authentication information using the certificate stored in the content storage unit 67, sends the created authentication information to the management server 5, and then performs authentication of the content stored in the content storage unit 67. At this time, the mobile terminal 6 performs the authentication by executing the file protection program acquired in step S409. The management server 5 receives the authentication information according to this authentication, updates information, for example, about “Lifetime” contained in the certificate, and then sends information for providing notification that the authentication is completed to the mobile terminal 6. Here, in the information about “Lifetime”, a period of validity period of the certificate, a count of validity to use the certificate, and the like are contained. The management server 5 updates these information by reducing a value of such information according to the authentication.

In response to this notification, the mobile terminal 6 performs processing for accessing the content and displaying details of the content on the display or the like.

As described above, the network system 110 according to the second embodiment, the mobile terminal 6 performs authentication of content and accesses it. Even if the data volume of content is so large that the content cannot be stored as a whole in the storage area of the certificate storage unit 25 of the mobile terminal 2 and thus cannot be processed, the management terminal 3 having a larger equipment size than this mobile terminal 2 acquires the content and performs authentication thereof and access thereto. However, in a case where the content can be completely stored in the storage area of the content storage unit 67 of the mobile terminal 6, after a trust relationship between the users A and B is confirmed, the mobile terminal 6 acquires a certificate which has been issued to the mobile terminal 1 having authority to access content, and then performs authentication and accesses the content, in a file sharing mode between the mobile terminal 6 and the mobile terminal 1. Thereby, compared to the conventional art, the risk of leaking a certificate and content to others is prevented so that enhanced security can be provided.

### A First Example corresponding to the First Embodiment

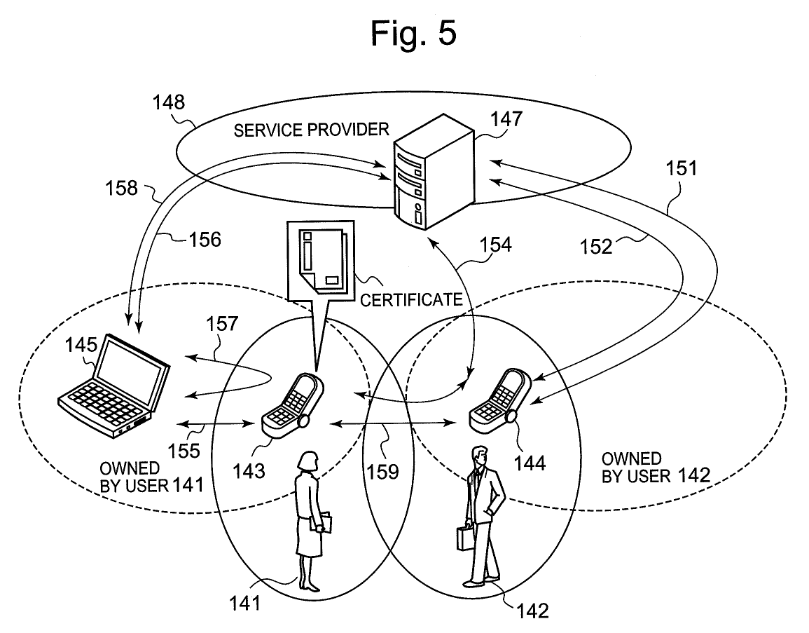

First, the first example corresponding to the first embodiment is described using a configuration diagram shown in FIG. 5. A user 141 carries a mobile terminal 143, and owns a notebook PC 145 which has a larger equipment size than this mobile terminal 143 and used for performing information management and the like. A user 142, who may be different from the user 141 or may be the same as the user 141, carries a mobile terminal 144 for generating and managing a plurality of kinds of content. A service provider 148 which provides a network that connects the mobile terminals 143, 144, the management terminal 145, and a management server 147 is installed which stores and manages content generated by the user 142 and a certificate corresponding to this content.

Subsequently, operation in the first example is described. First, when the mobile terminal 144 is operated by the user 142 to generate or acquire content, the mobile terminal 144 sends the content to the management server 147 and performs processing for storing the content sent from the mobile terminal 144 in the management server 147 (151). The management server 147 performs processing for creating and storing a certificate corresponding to the stored content. When the certificate is stored in the management server 147, the mobile terminal 144 creates and stores a list of content (152).

When the user 141 acquires the content, in response to confirmation of a trust relationship, for example, the users 141, 142 actually meeting in their sight, the mobile terminals 143, 144 connect to each other and perform communication processing, and further switch the communication mode from a normal wired or wireless communication to the file sharing mode and enable the limited communication function.

The mobile terminal 143 acquires the list of content from the mobile terminal 144 (153), and selects the content according to operation by the user 141. The mobile terminal 143 sends information for requesting the certificate of the selected content together. The mobile terminal 144, in response to this request, makes a request to the management server 147 for the certificate and acquires the certificate from the management server 147 based on the authority to access the content that is owned by the mobile terminal 144, and sends the certificate to the mobile terminal 143 using limited communication. The mobile terminal 143 acquires and stores the sent certificate (154).

The notebook PC 145 acquires a file protection program for performing authentication for accessing the content and identification information of the selected content from the mobile terminal 143 (155), and sends information for requesting the content corresponding to this identification information to the management server 147. The management server 147 reads out the content associated with the identification information in response to the request, and sends the content to the notebook PC 145. The notebook PC 145 receives and stores the sent content (156).

The notebook PC 145 sends information for requesting to create authentication information using the certificate, to the mobile terminal 143. In response to the request, the mobile terminal 143 creates the authentication information using the stored certificate and sends the authentication information to the notebook PC 145 (157).

Then, the notebook PC 145 acquires the authentication information sent from the mobile terminal 143, and sends the acquired authentication information to the management sever 147 and then performs authentication of the content (158). The management server 147 receives the authentication information according to the authentication, updates information, for example, about “Lifetime” contained in the certificate, and then sends information for providing notification that the authentication is completed to the notebook PC 145.

In response to this notification, the notebook PC 145 performs processing for accessing the content and displaying details of the content on the display or the like.

### A Second Example Corresponding to the First Embodiment

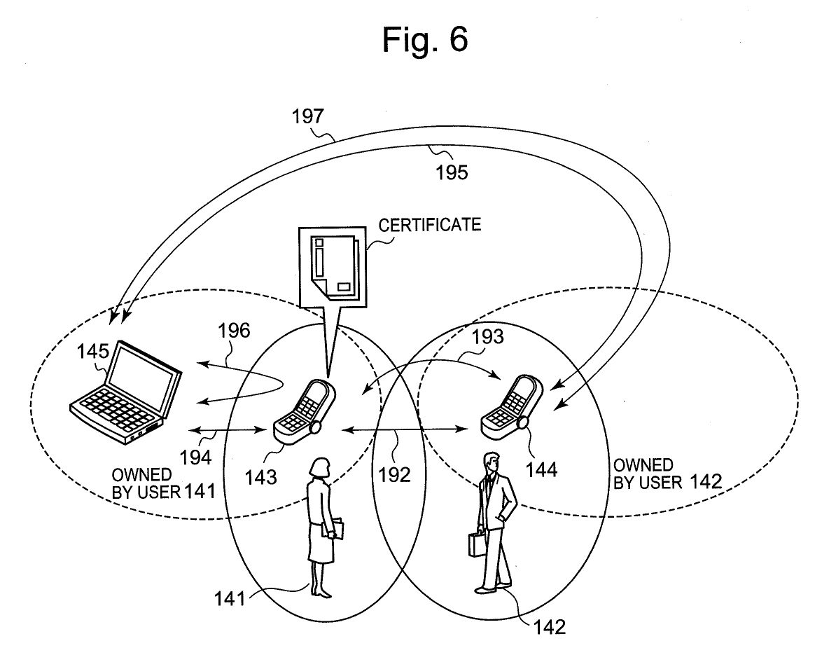

The second example corresponding to the first embodiment will be described using a configuration diagram shown in FIG. 6. As a configuration, the second example has the configuration of the first example from which the service provider 148 and the management server 147 are removed, in which content and a certificate are stored in the mobile terminal 144 instead of the management server 147. In the second example, a certificate is previously acquired before content is completely made, and the user 141 acquires the completed content after returning home.

Subsequently, operation according to the second example will be described. First, in the second example, the mobile terminal 144 is operated by the user 142, and then content is in process of being generated and is not yet stored in the mobile terminal 144. The mobile terminal 144 performs processing for creating a certificate corresponding to the content in process of being generated, and storing the certificate in advance. Then, after storing the certificate, the mobile terminal 144 accordingly creates a list as the content being generated and stores the list.

When the user 141 who is away from home acquires the content in process of being generated, in response to confirmation of a trust relationship, for example, the users 141, 142 actually meeting in their sight, the mobile terminals 143, 144 connect to each other and perform communication processing, and further switch the communication mode from a normal wired or wireless communication to the file sharing mode and enable the limited communication function.

The mobile terminal 143 acquires the list of content from the mobile terminal 144, and selects the content according to operation by the user 141 (192). The mobile terminal 143 sends information for requesting the certificate of the selected content together. In response to this request, the mobile terminal 144 sends the certificate to the mobile terminal 143 using limited communication. The mobile terminal 143 acquires and stores the sent certificate (193).

Then, after returning home, the user 141 uses the notebook PC 145 placed in the home. The notebook PC 145 acquires a file protection program for performing authentication for accessing the content and information such as a network address required for connecting to the mobile terminal 144, from the mobile terminal 143 (194).

At this point, the content which was in process of being generated by the mobile terminal 144 has been completed by the time the user 141 returns home, and processing for storing the content in the mobile terminal 144 in a manner to correspond to the previously created certificate has been performed.

The notebook PC 145 communicates with the mobile terminal 144 using the information such as the network address acquired from the mobile terminal 143, and sends information for requesting the content to the mobile terminal 144. The mobile terminal 144 reads out the content and sends it to the notebook PC 145 in response to this request. The notebook PC 145 receives and stores the sent content (195).

The notebook PC 145 sends information for requesting to create authentication information using the certificate, to the mobile terminal 143. In response to this request, the mobile terminal 143 creates the authentication information using the stored certificate and sends the authentication information to the notebook PC 145 (196).

Then, the notebook PC 145 acquires the authentication information sent from the mobile terminal 143, and sends the acquired authentication information to the management sever 147 and then performs authentication of the content (197). The management server 147 receives the authentication information according to this authentication, updates information, for example, about “Lifetime” contained in the certificate, and then sends information for providing notification that the authentication is completed to the notebook PC 145.

In response to this notification, the notebook PC 145 performs processing for accessing the content and displaying details of the content on the display or the like.

### A Third Example Corresponding to the Second Embodiment

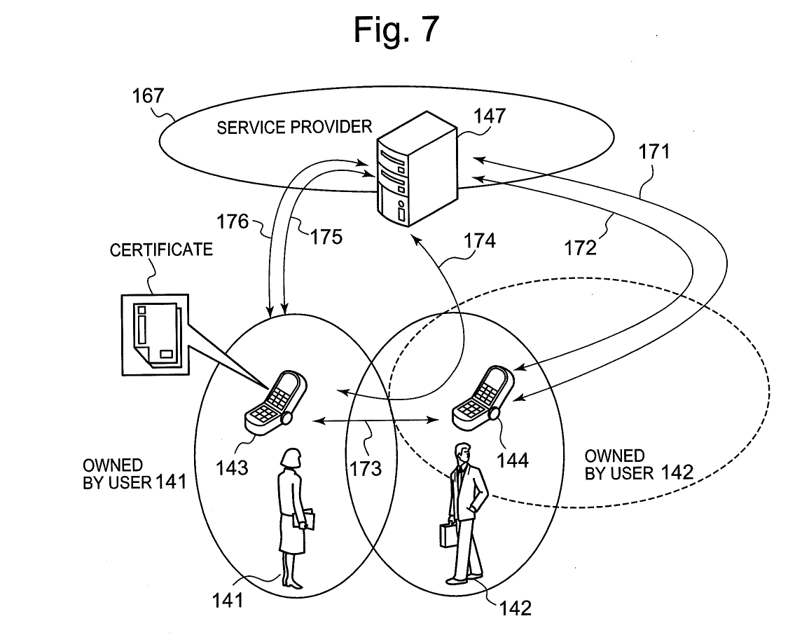

The third example corresponding to the second embodiment is described using a configuration diagram shown in FIG. 7. As a configuration, the third example has the configuration of the first example from which the notebook PC 145 is removed, in which instead of the notebook PC 145, the mobile terminal 143 performs acquisition and authentication of content, and access to the content. In the third example, in a case where content can be completely stored in the storage area of the mobile terminal 143 and can be processed, authentication and access are performed without using the notebook PC 145.

Subsequently, operation according to the third example is described. First, when the mobile terminal 144 is operated by the user 142 to generate or acquire content, the mobile terminal 144 sends the content to the management server 147, using service provider 167, and performs processing for storing the content sent from the mobile terminal 144 in the management server 147 (171). The management server 147 performs processing for creating and storing a certificate corresponding to the stored content. When the certificate is stored in the management server 147, the mobile terminal 144 creates and stores a list of content (172).

When the user 141 acquires the content, in response to confirmation of a trust relationship, for example, the users 141, 142 actually meeting in their sight, the mobile terminals 143, 144 connect to each other and perform communication processing, and further switch the communication mode from a normal wired or wireless communication to the file sharing mode and enable the limited communication function.

The mobile terminal 143 acquires the list of content from the mobile terminal 144 (173), and selects the content according to operation by the user 141. The mobile terminal 143 sends information for requesting the certificate of the selected content together. The mobile terminal 144, in response to this request, requests the certificate from the management server 147 and acquires the certificate from the management server 147 based on the authority to access the content that is owned by the mobile terminal 144, and sends the certificate to the mobile terminal 143 using limited communication. The mobile terminal 143 acquires and stores the sent certificate (174).

The mobile terminal 143 acquires a file protection program for performing authentication for accessing the content from an external network, and sends information for requesting the content corresponding to identification information of the selected content to the management server 147. The management server 147 reads out the content associated with the identification information in response to this request, and sends the content to the mobile terminal 143. The mobile terminal 143 receives and stores the sent content (175).

The mobile terminal 143 creates authentication information using the stored certificate, sends the created authentication information to the management server 147, and then performs authentication of the content (176). The management server 147 receives the authentication information according to this authentication, updates information, for example, about “Lifetime” contained in the certificate, and then sends information for providing notification that the authentication is completed to the mobile terminal 143.

In response to this notification, the mobile terminal 143 performs processing for accessing the content and displaying details of the content on the display or the like.

The network system, the network method, and the terminal and program therefore according to the above described embodiments and examples can prevent the risk of leaking content to others and provide enhanced security.

While embodiments and examples of the present invention have been described in detail above, it is contemplated that numerous modifications may be made to the above embodiments without departing from the spirit and scope of the embodiments of the present invention as defined in the following claims.

What is claimed is:

1. A network system comprising:
a first terminal having authority to access content; and
a second terminal,
wherein the first terminal comprises a first limited communication unit which performs limited communication with the second terminal,
wherein the second terminal comprises a second limited communication unit which performs limited communication with the first terminal; and
wherein the second terminal acquires certification information for authenticating access to the content from the first terminal, using the limited communication performed by the first and second limited communication units, if a predetermined relationship is confirmed between the first terminal and the second terminal.

2. The network system according to claim 1, further comprising:
a content storage unit which stores the content that the first terminal has the authority to access; and
a certification information storage unit which stores the certification information for authenticating access to the content stored by the content storage unit,
wherein the first terminal makes a request to the certification information unit for the certification information based on the authority to access the content, and
wherein the first limited communication unit sends the certification information, which is sent from the certification information storage unit in response to the request made by the first terminal, to the second terminal.

3. The network system according to claim 2, further comprising:
a third terminal,
wherein the third terminal comprises:
a content acquiring unit which acquires the content from the content storage unit;
an authentication information requesting unit which makes a request to the second terminal for authentication information created by using the certification information acquired by the second terminal, using the limited communication;
an authentication information acquiring unit which acquires the authentication information sent from the second terminal in response to the request for the authentication information made by the authentication information requesting unit; and
a first content authentication unit which authenticates the content acquired by the content acquiring unit, using the authentication information acquired by the authentication information acquiring unit.

4. The network system according to claim 2, further comprising:
a third terminal,
wherein the third terminal comprises;
a content acquiring unit which acquires the content from the content storage unit;
a certification information acquiring unit which acquires the certification information acquired by the second terminal, using the limited communication; and
a second content authentication unit which authenticates the content acquired by the content acquiring unit, using the certification information acquired by the certification information acquiring unit.

5. The network system according to claim 4,
wherein the third terminal further comprises a protection program acquiring unit configured to acquire a protection program for performing an authentication processing, and
wherein the second content authentication unit authenticates the acquired content, using the acquired certification information by executing the protection program acquired by the protection program acquiring unit.

6. The network system according to claim 2,
wherein the second terminal acquires the content from the content storage unit; and
wherein the second terminal authenticates the acquired content, using the certification information acquired by the second terminal using the limited communication.

7. The network system according to claim 6,
wherein the second terminal acquires a protection program for performing an authentication processing, and
wherein the second terminal authenticates the acquired content, using the acquired certification information by executing the acquired protection program.

8. The network system according to claim 2, further comprising a server:
wherein the server comprises the content storage unit and the certification information storage unit.

9. The network system according to claim 1,
wherein the certification information has a period or a count of validity for authenticating the access to the content.

10. A second terminal for communicating with a first terminal having authority to access content stored in a content storage unit, comprising:
a second limited communication unit which performs limited communication with the first terminal,
wherein the second terminal acquires certification information, which is sent to the first terminal from the certification information storage unit, from the first terminal, using the limited communication performed by the second limited communication unit.

11. A third terminal for communicating with a first terminal having authority to access content stored in a content storage unit and a second terminal capable of performing limited communication with the first terminal, comprising:
a content acquiring unit which acquires the content from the content storage unit;
a authentication information requesting unit which makes a request to the second terminal for authentication information created by using certification information for authenticating access to the content acquired by the second terminal, using the limited communication;
an authentication information acquiring unit which acquires the authentication information sent from the second terminal in response to the request for the authentication information made by the authentication information requesting unit; and
a first content authentication unit which authenticates the content acquired by the content acquiring unit, using the authentication information acquired by the authentication information acquiring unit.

12. A third terminal for communicating with a first terminal having authority to access content stored in a content storage unit and a second terminal capable of performing limited communication with the first terminal, comprising:
a content acquiring unit which acquires the content from the content storage unit;
a certification information acquiring unit which acquires certification information acquired by the second terminal, using the limited communication; and
a second content authentication unit which authenticates the content acquired by the content acquiring unit, using the certification information acquired by the certification information acquiring unit.

13. A network method comprising:
a limited communication operation comprising performing limited communication between a first terminal, having authority to access content, and a second terminal; and
a certification information sending operation comprising sending certification information for authenticating access to the content from the first terminal to the second terminal, using the limited communication performed by the limited communication operation, if a predetermined relationship is confirmed between the first terminal and the second terminal.

14. The network method according to claim 13 further comprising:
a content storing operation comprising storing, in a content storage unit, the content that the first terminal has the authority to access;
a certification information storing operation comprising storing, in a certification information storage unit, the certification information corresponding to the content stored by the content storing operation;
a certification information requesting operation comprising making a request from the first terminal to the certification information storage unit for the certification information based on the authority to access the content; and
wherein the certification information sending operation sends the certification information, which is sent from the certification information storage unit in response to the request made by the certification information requesting operation, to the second terminal.

15. A method with which a second terminal communicates with a first terminal having authority to access content stored in a content storage unit, comprising:
a limited communication operation comprising performing limited communication with the first terminal; and
a certification information acquiring operation comprising acquiring certification information, which is sent to the first terminal from a certification information storage unit, from the first terminal, using the limited communication performed by the limited communication operation.

16. The method according to claim 15 further comprising:
a content acquiring operation comprising acquiring the content from the content storage unit; and
an content authenticating operation comprising authenticating the content acquired by the content acquiring operation, using the certification information acquired by the certification information acquiring operation.

17. A method with which a third terminal communicates with a first terminal having authority to access content stored in a content storage unit and a second terminal capable of performing limited communication with the first terminal, comprising:
a content acquiring operation comprising acquiring the content from the content storage unit;
a authentication information requesting operation comprising making a request to the second terminal for authentication information created by using certification information for authenticating access to the content acquired by the second terminal, using the limited communication;
an authentication information acquiring operation comprising acquiring the authentication information sent from the second terminal in response to the request for the authentication information made by the authentication information requesting operation; and
a first content authentication operation comprising authenticating the content acquired by the content acquiring operation, using the authentication information acquired by the authentication information acquiring operation.

18. A method with which a third terminal communicates with a first terminal having authority to access content stored in a content storage unit and a second terminal capable of performing limited communication with the first terminal, comprising:
a content acquiring operation comprising acquiring the content from the content storage unit;
a certification information acquiring operation comprising acquiring certification information acquired by the second terminal, using the limited communication; and
a second content authentication operation comprising authenticating the content acquired by the content acquiring operation, using the certification information acquired by the certification information acquiring operation.

19. A tangible computer readable memory containing a program of instructions for enabling a computer for networking, to execute processes, comprising:
limited communication process comprising performing limited communication between a first terminal, having authority to access content, and a second terminal; and
certification information sending process comprising sending certification information for authenticating access to the content from the first terminal to the second terminal, using the limited communication performed by the limited communication process, if a predetermined relationship is confirmed between the first terminal and the second terminal.

20. The tangible computer readable memory containing a program according to claim 19 further comprising:
content storing process comprising storing, in a content storage unit, the content that the first terminal has the authority to access;
certification information storing process comprising storing, in a certification information storage unit, the certification information corresponding to the content stored by the content storing process;
first certification information requesting process comprising making a request from the first terminal to the certification information storage unit for the certification information based on the authority to access the content; and
wherein the certification information sending process sends the certification information, which is sent from the certification information storage unit in response to the request made by the certification information requesting process, to the second terminal.

21. A tangible computer readable memory containing a program of instructions for enabling a computer, serving as a second terminal that communicates with a first terminal having authority to access content stored in a content storage unit, to execute processes, comprising:
limited communication process comprising performing limited communication with the first terminal; and
certification information acquiring process comprising acquiring certification information, which is sent to the first terminal from the certification information storage unit, from the first terminal, using the limited communication performed by the limited communication process.

22. The tangible computer readable memory containing a program according to claim 21 further comprising:
content acquiring process comprising acquiring the content from the content storage unit; and
content authenticating process comprising authenticating the content acquired by the content acquiring process, using the certification information acquired by the certification information acquiring process.

23. A tangible computer readable memory containing a program of instructions for enabling a computer, serving as a third terminal that communicates with a first terminal having authority to access content stored in a content storage unit and a second terminal capable of performing limited communication with the first terminal, to execute processes, comprising:
content acquiring process comprising acquiring the content from the content storage unit;
authentication information requesting process comprising making a request to the second terminal for authentication information created by using certification information for authenticating access to the content acquired by the second terminal, using the limited communication;
authentication information acquiring process comprising acquiring the authentication information sent from the second terminal in response to the request for the authentication information made by the authentication information requesting process; and
first content authentication process comprising authenticating the content acquired by the content acquiring process, using the authentication information acquired by the authentication information acquiring process.

24. A tangible computer readable memory containing a program of instructions for enabling a computer, serving as a third terminal that communicates with a first terminal having authority to access content stored in a content storage unit and a second terminal capable of performing limited communication with the first terminal, to execute processes, comprising:
content acquiring process comprising acquiring the content from the content storage unit;
certification information acquiring process comprising acquiring certification information acquired by the second terminal, using the limited communication; and
second content authentication process comprising authenticating the content acquired by the content acquiring process, using the certification information acquired by the certification information acquiring process.
